(19) United States
(12) Patent Application Publication
(10) Pub. No.: US 2008/0140694 A1
(43) Pub. Date: Jun. 12, 2008

(54) DATA TRANSFORMATION BETWEEN DATABASES WITH DISSIMILAR SCHEMES

(76) Inventor: Yogesh Mangla, New Delhi (IN)

Correspondence Address: VIERRA MAGEN/MICROSOFT CORPORATION, 575 MARKET STREET, SUITE 2500, SAN FRANCISCO, CA, 94105, US

(21) Appl. No.: 11/608,059

(22) Filed: Dec. 7, 2006

(51) Int. Cl. G06F 17/30

(52) U.S. Cl. 707/102; 707/E17.044

(57) ABSTRACT

A source data field is transformed into a destination data field. A map defining the transformation is implemented by a user interface. The user interface allows the user to identify and select one or more source data fields and to transform the source data fields into selected destination data fields unit using simple programming language instructions, such as XML. In addition, the user interface provides a dialog that allows the user to incorporate one or more formulas into the transformation map. The maps may be saved individually or as a project including multiple maps.

### BACKGROUND

It is well known that data must sometimes be converted from one system to another system, or from one format to another format. Various reasons may underlie the conversion, such as a system upgrade (possibly forced by obsolescence), or a consolidation of data resources. However, in any data conversion project, a mapping strategy must be created that will reliably and efficiently transform data from the source system.

Often, companies spend large sums of money to have custom code written for converting data from a source system to a destination system. However, these efforts are generally limited to particular conversion parameters, and do not result in a generic conversion engine that can be utilized over and over for dissimilar data types. Thus, it remains desirable to develop an efficient, global solution to the problem of data conversion.

### SUMMARY

Data fields from a table in a source database can be mapped to data fields in a destination database accord with a transformation map. The transformation map is implemented via a user interface that allows the user to choose the database of interest, select source data fields to be transformed, and select destination data fields into which the transformed source data fields will be moved. The transformation map is preferably written using simple programming language instructions, such as XML.

In addition, the user interface provides a dialog that allows the user to incorporate one or more functions or formulas into the transformation map. The dialog may include a list of standard functions, e.g. SQL functions, that can be selected and used to create formulas that define part of the transformation map. Transformation maps may be saved individually or as a project including multiple maps.

This summary is provided to introduce a selection of concepts in a simplified form that are further described below. This summary is not intended to identify key features or essential features of the claimed subject matter, not is it intended to be used as an aid in determining the scope of the claimed subject matter.

### BRIEF DESCRIPTION OF THE DRAWINGS

FIG. 1 is a block diagram illustrating an exemplary network environment in which embodiments of the present disclosure may be implemented.

FIG. 2 is a block diagram illustrating the computing devices shown in FIG. 1 in greater detail.

FIG. 3A is a flow chart illustrating one simplified embodiment of the present disclosure.

FIG. 3B is a flow chart illustrating one embodiment of the present disclosure in greater detail.

FIG. 4 illustrates a first user interface that can be used to implement the embodiment of FIG. 3B.

FIG. 5 illustrates a second user interface that can be used in conjunction with the first user interface of FIG. 4.

### DETAILED DESCRIPTION

The present disclosure is directed to the use of a user interface to transform source data fields into destination data fields. The user interface allows the user to select a source database, then to select a source table from the source database, and then to choose source data fields within the selected source table to be transformed. Further, user interface allows the user to select corresponding destination data fields to be stored in a destination table. The user then defines a transformation map using the user interface that defines how to transform selected source data fields into selected destination data fields. The transformation map is stored as a map file in a markup language, such as XML. Individual transformation maps may be collected together and saved as a project. The user interface also permits functions and formulas to be incorporated into the transformation map.

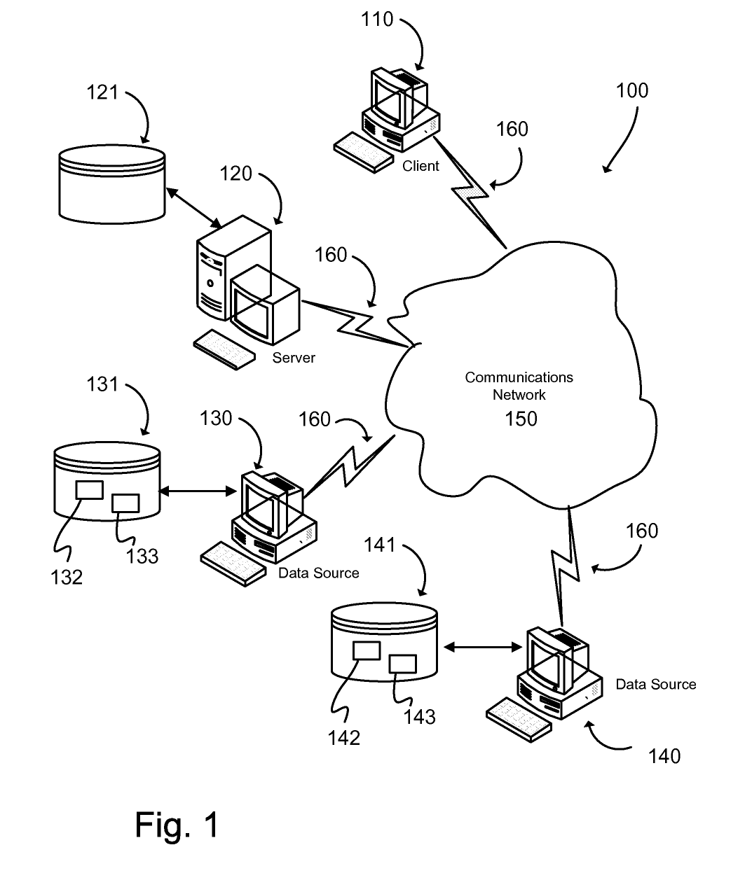

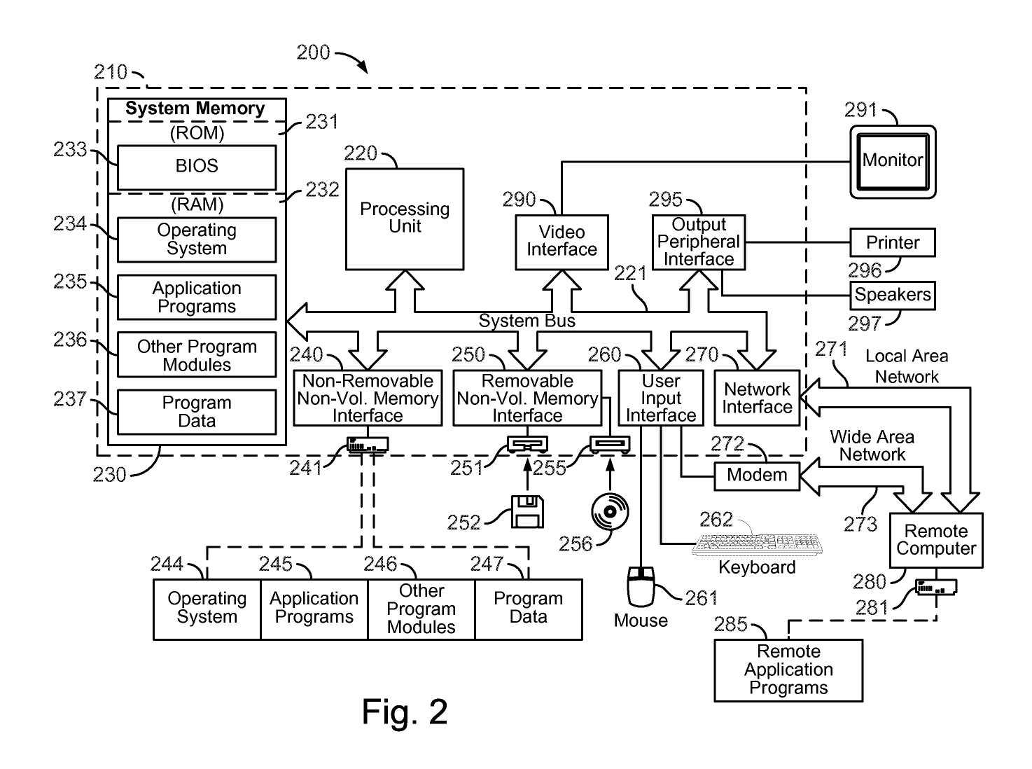

FIG. 1 illustrates an exemplary network environment 100 and FIG. 2 illustrates an exemplary computing environment 200 in which the disclosed technology may be implemented. These operating environments are only exemplary of suitable operating environments and are not intended to suggest any limitation as to the scope of use or functionality of the disclosed technology. Other well known networks, computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, and other distributed computing environments that include any of the above systems or devices, and the like.

In the exemplary environment of FIG. 1, the network 100 may include client computer 110, server computer 120, data source computer(s) 130, 140, and databases 121, 131, 141. There of course may be multiple client computers or server computers, and the present description is not meant to be limiting. The focus of this disclosure, however, is a conversion process that maps data stored in database 131 to database 141.

The client computer 110 and the data source computers 130, 140 are in communication with the server computer 120 via communications network 150, e.g., an Internet. Computers 110, 120, 130, 140 are connected to the communications network by way of communications interfaces 160. Communications interfaces 160 can be any one of the well-known communications interfaces such as Ethernet connections, modem connections, and so on, and may be different for each of the computers.

Server computer 120 provides management of database 121 by way of database server system software, which may conform, for example, to the relational data model. As such, server 120 acts as a storehouse of data and provides that data to a variety of data consumers.

In the example of FIG. 1, data sources are provided by data source computers 130, 140. Data source computers 130, 140 communicate data to server computer 120 via communications network 150, which may be a LAN, WAN, Intranet, Internet, or the like. Data source computers 130, 140 store data locally in databases 131, 141, respectively, which may be relational database servers. For example, relational database 131 shows data stored in tables 132, 133, and relational database 141 shows data stored in tables 142, 143. In the example shown in FIG. 1, the data provided by data sources 130, 140 may be combined and stored in a large database, such as a data warehouse maintained by server 120.

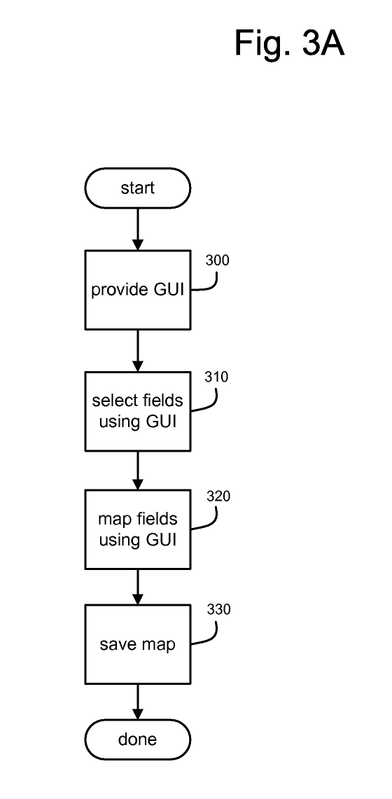

Client computer 110 that desires to use the data stored by server computer 120 can access the database 121 via communications network 150. Client computer 110 requests the data by way of queries. In the embodiment disclosed in FIGS. 3-5, client computer queries may conform to the XML data model. The mapping component, that advantageously maps data conforming from one data model (e.g. XML) to data conforming to another data model (e.g. SQL) can be located on any of the client computer 110, server computer 120, or data source computers 130, 140.

Turning now to FIG. 2, an exemplary computing environment 200 is illustrated in which a general purpose computing device in the form of a computer 210 may be utilized to implement client computer 110, server computer 120, and/or data source computer 130, 140. Components of computer 210 may include, but are not limited to, a processing unit 220, a system memory 230, and a system bus 221 that couples various system components including the system memory to the processing unit 220. The system bus 221 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 210 typically includes a variety of computer readable media. Computer readable media can be any available media that can be accessed by computer 210 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or present technology for storage of information such as computer readable instructions, data structures, program modules or other data. Computer storage media includes, but is not limited to, RAM, ROM, EEPROM, flash memory or other memory present technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 210. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 230 includes computer storage media in the form of volatile and/or nonvolatile memory such as read only memory (ROM) 231 and random access memory (RAM) 232. A basic input/output system 233 (BIOS), containing the basic routines that help to transfer information between elements within computer 210, such as during start-up, is typically stored in ROM 231. RAM 232 typically contains data and/or program modules that are immediately accessible to and/or presently being operated on by processing unit 220. By way of example, and not limitation, FIG. 2 illustrates operating system 234, application programs 235, other program modules 236, and program data 237.

The computer 210 may also include other removable/non-removable, volatile/nonvolatile computer storage media. By way of example only, FIG. 2 illustrates a hard disk drive 240 that reads from or writes to non-removable, nonvolatile magnetic media, a magnetic disk drive 251 that reads from or writes to a removable, nonvolatile magnetic disk 252, and an optical disk drive 255 that reads from or writes to a removable, nonvolatile optical disk 256 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 241 is typically connected to the system bus 221 through a non-removable memory interface such as interface 240, and magnetic disk drive 251 and optical disk drive 255 are typically connected to the system bus 221 by a removable memory interface, such as interface 250.

The drives and their associated computer storage media discussed above and illustrated in FIG. 2, provide storage of computer readable instructions, data structures, program modules and other data for the computer 210. In FIG. 2, for example, hard disk drive 241 is illustrated as storing operating system 244, application programs 245, other program modules 246, and program data 247. Note that these components can either be the same as or different from operating system 234, application programs 235, other program modules 236, and program data 237. Operating system 244, application programs 245, other program modules 246, and program data 247 are given different numbers here to illustrate that, at a minimum, they are different copies. A user may enter commands and information into the computer 210 through input devices such as a keyboard 262 and pointing device 261, commonly referred to as a mouse, trackball or touch pad. Other input devices (not shown) may include a microphone, joystick, game pad, satellite dish, scanner, or the like. These and other input devices are often connected to the processing unit 220 through a user input interface 260 that is coupled to the system bus, but may be connected by other interface and bus structures, such as a parallel port, game port or a universal serial bus (USB). A monitor 291 or other type of display device is also connected to the system bus 221 via an interface, such as a video interface 290. The monitor 291 can be driven through the video interface 290 with software routines from processor 220 that cause a graphical user interface (GUI) to be displayed on the monitor that works in conjunction with input devices to provide commands and information to relevant portions of the computing device 210. A specific GUI that facilitates migrating data from one database to another will be described below. In addition to the monitor, computers may also include other peripheral output devices such as speakers 297 and printer 296, which may be connected through an output peripheral interface 290.

The computer 210 may, for example, be the client computer 110 operating in a networked environment, such as network 110, using logical connections to one or more remote computers, such as a remote computer 280. The remote computer 280 could, for example, be any of the computers 120, 130, 140 shown in FIG. 1, and in general could be a personal computer, a server, a router, a network PC, a peer device or other common network node, and typically includes many or all of the elements described above relative to the computer 210, although only a memory storage device 281 has been illustrated in FIG. 2. The logical connections depicted in FIG. 2 include a local area network (LAN) 271 and a wide area network (WAN) 273, but may also include other networks. Such networking environments are commonplace in offices, enterprise-wide computer networks, intranets and the Internet, and need not be described in detail here.

When used in a LAN networking environment, the computer 210 is connected to the LAN 271 through a network interface or adapter 270 (which may be the same as interface 160 in FIG. 1). When used in a WAN networking environment, the computer 210 typically includes a modem 272 or other means for establishing communications over the WAN 273, such as the Internet. The modem 272, which may be internal or external, may be connected to the system bus 221 via the user input interface 260, or other appropriate mechanism. In a networked environment, program modules depicted relative to the computer 210, or portions thereof, may be stored in the remote memory storage device. By way of example, and not limitation, FIG. 2 illustrates remote application programs 285 as residing on memory device 281. Likewise, remote data storage may be available on databases 131, 141, through data source computers 130, 140, respectively. It will be appreciated that the network connections shown are exemplary and other means of establishing a communications link between the computers may be used.

The present disclosure includes subject matter that may be described in the general context of computer-executable instructions, such as program modules, being executed by a computer. Generally, program modules include routines, programs, objects, components, data structures, etc., that perform particular tasks or implement particular abstract data types. The techniques described herein may also be practiced in distributed computing environments where tasks are performed by remote processing devices that are linked through a communications network. In a distributed computing environment, program modules may be located in both local and remote computer storage media including memory storage devices.

FIG. 3A shows an embodiment of a computer-executable method for transforming data fields from a source to a destination. For the purposes of this example. the source data fields are stored in tables in the source database, such as database 131, and will be transformed into destination data fields stored in a destination table, which may then be moved to a new database, such as database 141. The method may be performed using client computer 110, for example, to access and manipulate the data. This example is intended to be illustrative and not limiting.

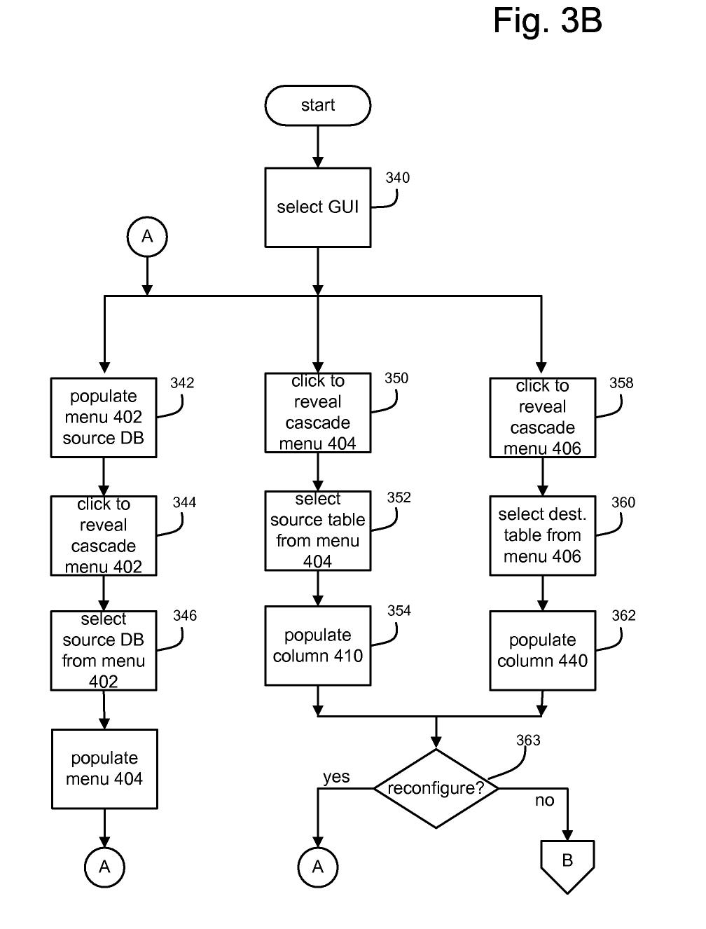

In step 300, a graphical user interface (GUI) is provided that gives the user a simple visual tool to select and map the source and destination fields. An example of a suitable GUI 400 to implement the method of FIG. 3A is illustrated in FIG. 4, and a more detailed method of using the GUI 400 is illustrated in FIG. 3B, described below. The GUI 400 is rendered with a markup language, such as XML, using well known methods, and is supported by a middle tier code that allows, for example, one-to-one mapping of fields, formula defined fields, data transforming fields, and other relevant field operations. Middle tier solutions are frequently stored procedures, and the primary activities are reading and writing data. Reading data involves retrieving the raw data based on input parameters, manipulating the data as necessary, then delivering the data in the requested format. Writing data involves manipulating stored data using certain rules and processes.

A “middle tier” architecture typically resides on a web server, although it can and should be transportable and independent from any particular operating platform. The three tier model defines the browser as the client tier, the database as the back-end tier, and the web server and its extensions as the middle tier. Software solutions implemented in the middle tier are called “middleware,” and there are many good examples, including ColdFusion, PHP, J2EE, .NET, etc.

A middle tier solution should be easy to find and call in any environment. In the traditional Java environment, the code must be created and compiled before it can be called. With stored procedures, this is an easy task. In the SQL server, the developer just types the procedure name, enters the appropriate arguments, and hits the execute button. Results are then delivered in a predefined format (rows and columns).

In step 302, the user interacts with the GUI 400 to select the source and destination fields from tables in a source database. In step 304, the user interacts with the GUI 400 to map a transformation scheme for selected data fields. Such a mapping may include one-to-one mapping, formula-defined fields, and other known field operations. In step 306, the map is saved, e.g., as an XML file, for later use.

As previously noted, a more detailed method for using GUI 400 to implement a data transformation method is illustrated in the flow chart of FIG. 3B. The task is to migrate data regarding suppliers, their parts and prices, from one database to another database although this is merely exemplary and any conceivable data conversion task could be identified and implemented. As noted above, the processor 220 runs software routines for displaying a GUI on monitor 291 through video interface 290. The development of such routines is considered to be within the skill of the artisan when given a visual specification, such as depicted in FIG. 4.

In step 340 of FIG. 3B, a GUI or window 400 is chosen for display on the user's computer, for example, client computer 110. The window 400 is thus rendered during an initialization stage using a mark-up language rendering engine (i.e., program). Rendering engines are well-known, such as the rendering engine provided within Internet Explorer. As noted, a mark-up language is used to create the window 400, preferably extensible Markup Language (XML), according to well know methods.

In step 342, a first menu 402 displayed in window 400 is populated with a series of menu entries that list all possible choices for the source database that are accessible and available as part of network 150. The remaining choices are presented as a cascaded menu that is revealed when the user clicks on pull-down arrow 403 of menu 402.

In step 344, the user clicks on arrow 403 to reveal the cascaded menu. In step 346, the user selects one of the cascaded menu entries by clicking on one of the entries with a selection device, e.g., a mouse. In FIG. 4, the selected entry is “Master DB.”

After the user has selected the source database from menu 402, menus 404 and 406 are populated with a series of menu entries that list all possible choices for tables within the selected source database in step 348. In both menus 404, 406, the choices are again presented as a cascaded menu that reveals all cascaded menu entries when the user clicks on pull-down arrow 405 or 407, respectively.

In step 350, the user clicks on arrow 405 to reveal the cascaded menu entries listing choices for tables from the source database. In step 352, the user selects one of the cascaded menu entries as the source table by clicking on a entry with the mouse. In FIG. 4, the selected entry is “Supplier.”

In step 354, after the user has selected the source table from menu 404, a first column 410 displayed in window 400 is populated with a series of data fields that are associated with the table “Supplier” in the database “MasterDB.” In FIG. 4, the data fields in column 410 are identified as “Pkid,” “Name,” “Address,” “Phone,” and “Contact.”

In step 358, the user clicks on pull-down arrow 407 to reveal all the cascaded menu entries listing choices for tables from the source database. In step 360, the user selects one of the cascaded menu entries as the destination table by clicking on the desired menu entry. In FIG. 4, the selected entry is “Supplier Part.”

In step 362, after the user has selected the destination table from menu 406, a second column 440 displayed in window 400 is populated with a series of data fields that are associated with the table “Supplier Part” in the database “MasterDB.” In FIG. 4, the data fields in column 440 are identified as “Pkid,” “Supplier_Pkid,” “Part_Pkid,” “Inventory,” “Delivery Date,” “Price,” and “Total Worth of Parts For Supplier.”

It is noted that the steps for selecting a source table and a destination table are not required to be performed in sequence. Further, in step 363, the user could return to any of steps 342, 350, or 358, to reselect and reconfigure the desired transformation.

In step 364, the user selects source fields for transformation from column 410, for example, by clicking on them with the mouse. In step 366, the user moves selected source fields into column 420. This can be accomplished by clicking on button 412 thereby moving the selected source fields into column 420. An alternative to steps 364/366 is step 365, wherein by clicking on button 414, all the source fields listed in column 410 will be moved into column 420. Another alternative to steps 364-366 is step 363.

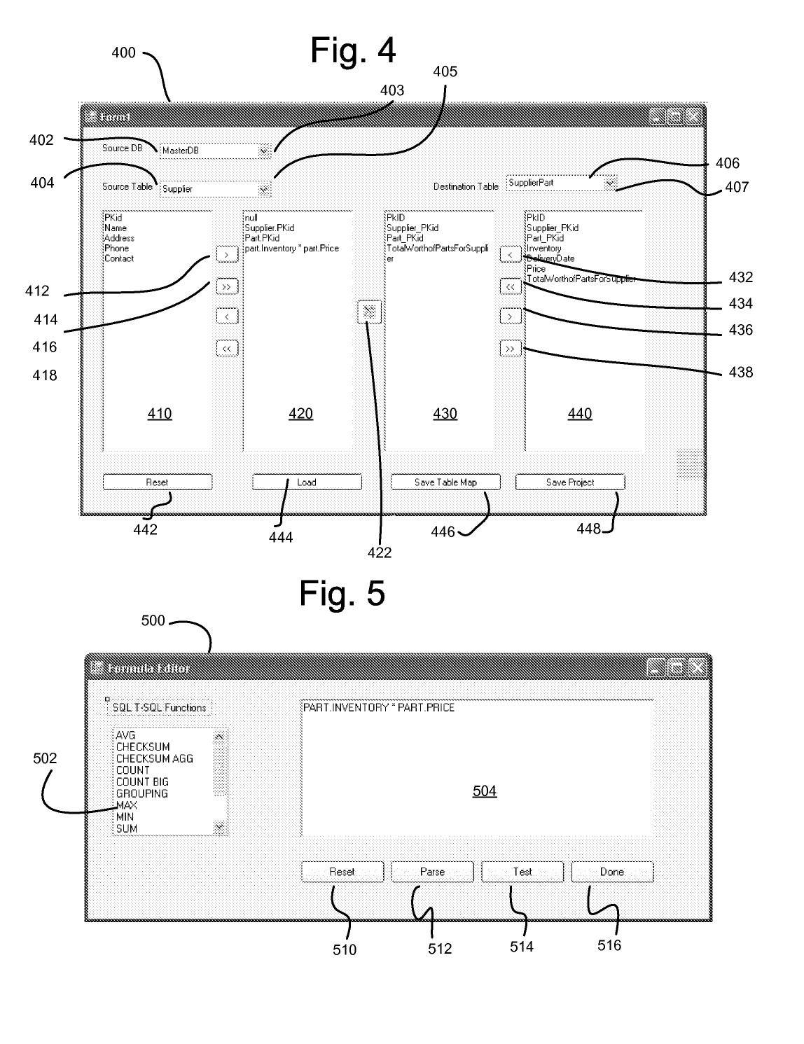

In step 369, the user incorporates a formula into column 420 by clicking the “tool box” button 422 located between columns 420, 430. When the tool box button 422 is selected, a new dialog box 500 will be promoted to the user, as shown in FIG. 5. The dialog box 500 is used to create formulas to be used as a data source to the destination fields. The formula may use one or more source fields and can also be based on system parameters. In this example, T-SQL functions are listed in box 502. Any listed function could be utilized in a valid T-SQL expression and entered into box 504. For example, the function shown in box 504 takes the value in field “PART.INVENTORY” and multiples it by the value in field “PART.PRICE.” According to columns 420, 430, the resultant value of this expression is then stored into field “TotalWorthofPartsForSupplier.” Prior to finalizing the formula and having it inserted into column 420, it may be validated by pressing the “Parse” button 512. This checks the syntax of the expression and reports back errors, if any. Pressing the “Test” button 514 returns a single value if that is the result contemplated by the expression. In the case of data rows being returned, the user is informed accordingly.

In step 367, the user may return to un-select fields from column 420 and move them back to column 410, or may proceed to step 374. In step 368, the user selects fields listed in column 420 by clicking on them. In step 370, the user clicks on button 416, and the selected data fields are moved from column 420 back to column 410. In alternative step 372, the user clicks on button 418, and all data fields in column 420 are moved back into column 410.

Steps 374-382 provide a destination field selection process that corresponds to the source field selection process depicted in steps 364-372. In step 374, the user selects data fields from column 440 to be the targets of the transformed source fields by clicking on them with the mouse. In step 376, the selected fields are moved into column 430 by clicking on button 412. An alternative to steps 374-376 is step 375, where the user clicks button 414 to move all the destination fields listed in column 440 into column 430.

In step 377, the user may return and un-select fields from column 430 and move them back to column 440, or proceed to step 384. In step 378, the user selects data fields in column 420 by clicking on them. In step 380, the user clicks on button 416, and the selected data fields are moved from column 430 back to column 440. In alternative step 382, the user clicks on button 418, and all data fields in column 430 are moved back into column 440.

When all field entries have been finalized, the transformation is defined by the correlation between the source fields listed in column 420 and the destination fields listed in column 430. The transformation (or map) can then be saved in step 384 as an XML file by clicking button 446 entitled “Save Table Map.” Any previously saved table map can be retrieved by selecting button 444 entitled “Load.” Multiple table maps can be saved as part of a larger transformation project by clicking button 448 entitled “Save Project.” Any previously saved project can be retrieved by selecting Load button 444. Selecting button 442 entitled “Reset” will cause all fields to be cleared from columns 420, 430.

A schema is thus defined by a user to define the transformation of data fields and is stored in XML format. Editing of the schema can be done using notepad or any other common text editor. The schema utilizes common structural relationships, and in the current example, the databases contain tables, the tables contain fields, and fields hold data. Although the fields normally contain scalar values, they could hold more complex data types (such as XML or UDT).

One exemplary schema for defining a simple data translation is listed below.

| | |
|---|---|
| 1 | <?xml version=“1.0”?> |
| 2 | <Project> |
| 3 | <Table> |
| 4 | <Mapping> |
| 5 | <Source>null</Source> |
| 6 | <Destination>Supplier.SupplierPart.PKid</Destination> |
| 7 | </Mapping> |
| 8 | <Mapping> |
| 9 | <Source>MasterDB.Supplier.PkID</Source> |
| 10 | <Destination>Supplier.SupplierPart.Supplier_PKid</ |
| | Destination> |
| 11 | </Mapping> |
| 12 | <Mapping> |
| 13 | <Source>MasterDB.Part.PkID</Source> |
| 14 | <Destination>Supplier.SupplierPart.Part_PKid</ |
| | Destination> |
| 15 | </Mapping> |
| 16 | <Mapping> |
| 17 | <Source>MasterDB.Part.Inventory*MasterDB.Part.Price</ |
| | Source> |
| 18 | <Destination>Supplier.TotalWorthofPartforSupplier</ |
| | Destination> |
| 19 | </Mapping> |
| 20 | </Table> |
| 21 | <Table> |
| 22 | <Mapping> . . . . . . . |
| 23 | </Table> |

Thus, in this example, a table is defined by a series of mapping steps. The first line of the code identifies the XML version used, e.g., XML version 1.0. The second line of the code identifies the start of a definition for a relational element or object, namely a project (<Project>), and the third line of code defines another object, namely a table (<Table>). Line 20 shows the ending of the Table object (</Table). In between, lines 4-19 define how the table object is constructed, and in this example, all these steps are mapping steps. Thus, lines 4-7 are used to identify and populate the destination field. The source is defined as null, and the destination is defined as “Supplier.SupplierPart.PKid,” i.e., the destination field will store information mapped from the “Supplier” table to the “SupplierPart” table, and the first field will be “PKid.” Lines 8-11 define a mapping from the field “Supplier.PKid” to the field “Supplier_PKid.” Lines 12-15 define a mapping from the field “Part.PKid” to the field “Part_PKid.” Lines 16-19 define a mapping using a formula that multiplies the value in field “Part.Inventory” by the value in field “Part.Price” and stores the results in field “TotalWorthofPartsForSupplier.” Lines 21-23 are included to illustrate that another Table definition could be defined as another series of mapping steps. The simplicity of markup languages permits the user to define a tag and then describe the tag and its uses.

Although the subject matter has been described in language specific to structural features and/or methods, it should be understood that the subject matter defined in the appended claims is not necessarily limited to the specific features or methods described above. Rather, the specific features and methods described above are disclosed as example forms of implementing the claims.

I claim:

1. A method for transforming data fields, comprising:
providing a first user interface that displays menus for selecting data fields;
receiving a selection of at least one source data field and one destination data field from the first user interface;
mapping a transformation of the source data field into the destination data field using the first user interface; and
storing the mapping as a markup language file.

2. The method of claim 1, wherein the providing step renders the user interface using the markup language, and the mapping step creates the transformation using the markup language.

3. The method of claim 2, wherein the markup language is XML.

4. The method of claim 1, wherein the mapping step defines a one-to-one relationship between the source data field and the destination data field.

5. The method of claim 1, wherein the mapping step defines a relationship between the source data field and the destination data field using at least one formula.

6. The method of claim 1, wherein the first user interface displays a menu for selecting a database, and wherein the receiving step further comprises receiving a selection of a database from the first user interface.

7. The method of claim 1, further comprising providing a second user interface that permits selection of additional functions to be incorporated into the mapping step.

8. The method of claim 7, wherein the first user interface includes an action element that, when activated, calls the second user interface.

9. A computing device, comprising:
a processing unit;
a storage device in communication with the processing unit, the storage device including a software component having instructions executable by the processing unit, said instructions including a map that defines at least one transformation relationship between a source data field and a destination data field; and
a first user interface in communication with the processing unit and the storage device and having a first selection area and a second selection area;
wherein at least one source data field is selected in the first selection area and at least one destination data field is selected in the second selection area; and
wherein the map is applied to transform the selected source data field and store a result of the transformation in the selected destination data field.

10. The computing device of claim 9, the first user interface further comprising a third selection area, wherein a source database is selected in the third selection area.

11. The computing device of claim 10, wherein:
the first selection area further comprises a first source region listing available data fields from the selected source database and a second source region;
the second selection area further comprises a first destination region listing available data fields from the selected source database and a second destination region;
the first user interface further comprises a first action element that, when activated, moves selected data fields from the first source region to the second source region; and a second action element that, when activated, moves selected data fields from the first destination region to the second destination region, and
wherein the selected source data fields are transformed and stored into the selected destination data fields in accord with the map.

12. The computing device of claim 9, wherein the first user interface further comprises a third action element that, when activated, calls a second user interface that permits selection of additional functions to be incorporated into the map.

13. The computing device of claim 12, wherein the second user interface includes a fourth action element that, when activated, selects at least one formula to be incorporated into the map.

14. The computing device of claim 12, wherein the second user interface includes a first region for writing formulas.

15. The computing device of claim 14, wherein the second user interface includes a second region for choosing functions to use in writing formulas in the first region.

16. The computing device of claim 9, wherein the first user interface includes a fourth action element that, when activated, saves one map as a table map.

17. The computing device of claim 16, wherein the first user interface includes a fifth action element that, when activated, saves multiple maps as a project.

18. A computer-readable medium having computer-executable instructions for programming a computer to perform a method for transforming a source data field into a destination data field, comprising:
providing a first user interface that displays menus for selecting data fields;
receiving a selection of at least one source data field and at least one destination data field from the first user interface;
transforming the source data field into the destination data field using the first user interface to map the relationship between the data fields; and
storing the transforming step as a markup language file.

19. The computer-readable medium of claim 18, wherein the transforming step includes incorporating formulas to map the relationship between the data fields.

20. The computer-readable medium of claim 19, further comprising providing a second user interface that permits selected functions to be incorporated into the transforming step.
